(19) United States
(12) Patent Application Publication
(10) Pub. No.: US 2009/0321528 A1
(43) Pub. Date: Dec. 31, 2009

(54) 2-D CODED PINS FOR USE WITH ELECTRONIC DEVICES

(76) Inventor: Simon Norridge, Cranston, RI (US)

Correspondence Address: GAUTHIER & CONNORS, LLP, 225 FRANKLIN STREET, SUITE 2300, BOSTON, MA, 02110, US

(21) Appl. No.: 12/164,689

(22) Filed: Jun. 30, 2008

(51) Int. Cl. G06K 19/02; B32B 37/00

(52) U.S. Cl. 235/488; 156/60

(57) ABSTRACT

A laminated structure is provided. The laminated structure includes an ornamental layer providing structural support and decorative graphics. A substrate is positioned below the ornamental layer. The substrate includes a contact surface on which coded information is printed. The coded information includes information associated with a uniform remote location (URL) used in downloading selective content information to a portable electronic device. An adhesive layer is positioned and totally encompasses the contact surface and the coded information. The adhesive layer is constructed and arranged to adhere to the surface of a portable electronic device.

### BACKGROUND OF THE INVENTION

The invention relates to the field laminated structures, and in particular to a laminated structure used for retrieving information using portable electronic devices or other electronic equipment.

Adhesive-coated stickers are flexible material sheets that are coated, on one side, with an adhesive layer, which is subsequently covered by a non-stick material sheet. In order to apply the sticker to a surface, the non-stick material sheet is peeled off the coated surface and the coated surface is then pressed against the surface over which the sticker is to be posted. The flexible material of a sticker can be made of paper, fibrous sheet, plastic film (which may be transparent, translucent or opaque), metal foil or other materials known in the art. The non-stick material sheet may be made of silicone-coated, wax-coated, Teflon-coated or some other non-stick material-coated paper, fibrous sheet, plastic film, metal foil or other non-stick materials commonly known in the art as release-coated materials or paper sheets.

### SUMMARY OF THE INVENTION

According to one aspect of the invention, there is provided a laminated structure. The laminated structure includes an ornamental layer providing structural support and decorative graphics. A substrate is positioned below the ornamental layer. The substrate includes a contact surface on which coded information is printed. The coded information includes information associated with a uniform remote location (URL) used in downloading selective content information to a portable electronic device. An adhesive layer is positioned and totally encompasses the contact surface and the coded information. The adhesive layer is constructed and arranged to adhere to the surface of a portable electronic device.

According to another aspect of the invention, there is provided a method of forming a laminated structure. The method includes forming an ornamental layer that provides structural support and decorative graphics. Also, the method includes positioning a substrate below the ornamental layer. The substrate includes a contact surface on which coded information is printed. The coded information includes information associated with a uniform remote location (URL) used in downloading selective content information to a portable electronic device. Furthermore, the method includes forming an adhesive layer being positioned and totally encompasses the contact surface and the coded information. The adhesive layer is constructed and arranged to adhere to the surface of the portable electronic device.

### BRIEF DESCRIPTION OF THE DRAWINGS

FIGS. 1A-1C are schematic diagrams illustrating the top view, bottom view, and operational view of the inventive laminated structure;

FIG. 2 is a cross-sectional view of the inventive laminated structure; and

FIG. 3 is a schematic diagram illustrating the flexibility of the inventive laminated structure.

### DETAILED DESCRIPTION OF THE INVENTION

The invention provides a novel approach for users retrieving information using portable electronic devices or other electronic equipment. The invention allows users to retrieve selected information from a remote location using a laminated structure. The laminate structure includes specialized coded information that instructs a portable electronic device to access a uniform remote location (URL) to retrieve selective content information.

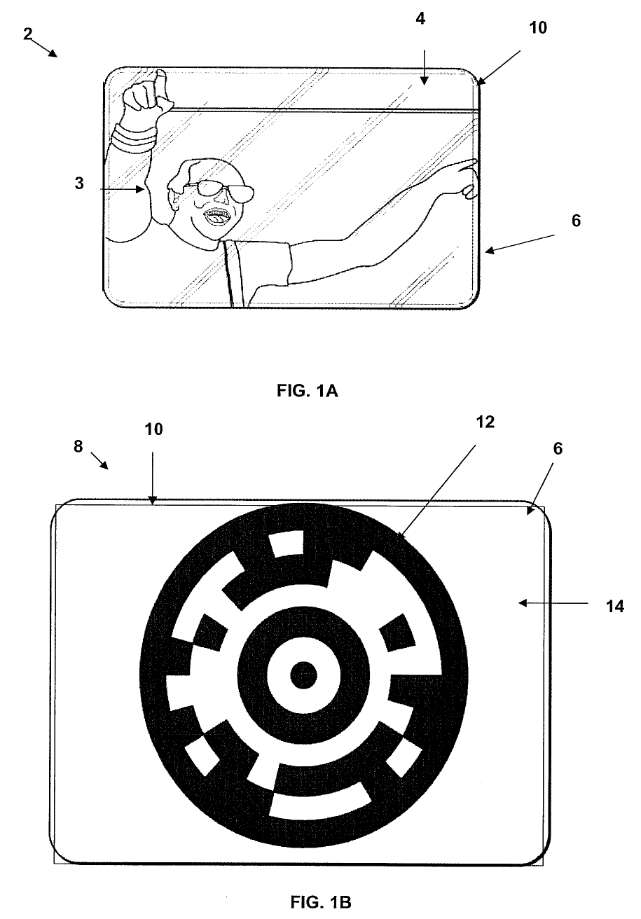

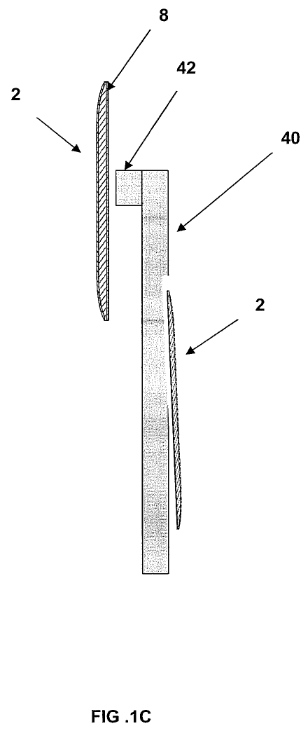

FIGS. 1A-1B are schematic diagrams illustrating the top view and bottom view of the inventive laminated structure 2. FIG. 1A is a top view of the laminated structure 2. The laminated structure 2 includes an ornamental layer 4 having specifically arranged designs, locos, color pictures, symbols, or other decorative graphics 3. The ornamental layer 4 is formed with a resin that allows it to be flexible and water-resistant as well as controlling swearing or fading of the decorative graphics 3. Also, the laminated structure 2 includes a substrate 10 and adhesive layer 6. The substrate 10 includes a contact surface 14 on its bottom side 8 where coded information 12 is imprinted on. An adhesive layer 6 is positioned over the contact surface 14 and comprises a coated region of a specified adhesive, as shown in FIG. 1B.

The adhesive layer 6 is used to stick on various portable electronic devices 40, such as PDAs, Blackberries, IPODs, or other handhelds that have a camera included therein, as shown in FIG. 1C. Also, an end-user would easily peel off the laminate structure 2 from the portable electronic device 40 and position the bottom region of the laminate structure 2 near the camera component 42 of their portable electronic device 40 and take a picture of the contact surface 14 that includes the coded information 12. The portable electronic device 40 includes specific software that executes once the photograph of the bottom region is taken to read the coded information 12 associated with an URL and access that location.

In the exemplary embodiment, the portable electronic device 40 includes web accessibility. The specific software utilizes the web accessibility of the portable device 40 to access the URL location. Once the URL is accessed, user specified content, such as free music, ring tones, video, games, concert tickets, or the like, is downloaded to the end-user's portable electronic device 40. The adhesive of the adhesive layer 6 must be made of transparent material so as to allow camera 42 to take a picture without smudges distorting the view of the coded information 12.

The dimensions of the laminate 2 can vary to any size preferred. Also, the adhesive layer 6 can be re-used on other portable electronic devices without leaving a residue or damaging the surface of the portable electronic device. The coded information 12 is one of many types of coded information that can be used in accordance with the invention, such as 2-D coded symbols or graphical sequences.

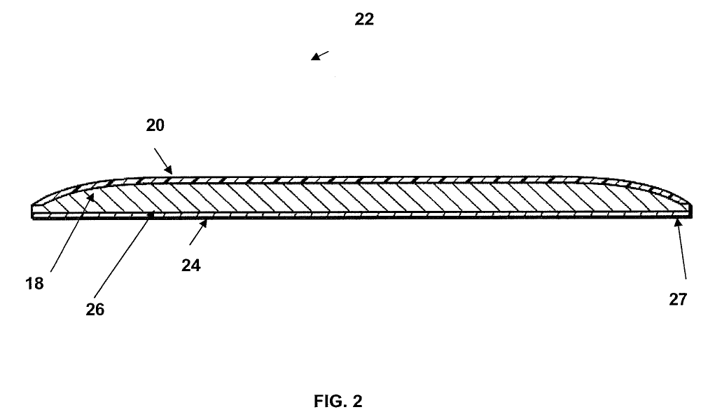

FIG. 2 is a cross-sectional view of the inventive laminate structure 22. The laminate structure 22 includes an ornamental layer 20, a structural layer 18, substrate 26 and an adhesive layer 24. The structural layer 18 is disposed between the ornamental layer 20 and the substrate 26, and is adapted to provide structural stability to the laminate structure 22. The ornamental layer 20 can provide further structural support to additionally stabilize the laminate structure 22.

In one embodiment, the ornamental layer 14 includes a flexible epoxy, formed using a resin, that can be manipulated to provide decorative graphics, e.g., by an air brush technique. In another embodiment, the flexible epoxy can be applied to a separate graphics layer. In another embodiment, the ornamental layer 20 embodies a see-through layer that enables graphics provided on the structural layer 16 to show through the ornamental layer 20.

The structural layer 18 can include a vinyl material constructed and arranged to support the laminate structure 22. Also, the ornamental layer 20 can be applied to the structural layer 18. In another embodiment of the invention, the structural layer 18 can include a thin sheet of metal, such as aluminum as well as provides a decorative element.

The coded information is imprinted on a contact surface 27 located on the bottom side of the substrate 26 using a specialized marking instrument. The adhesive layer 24 totally encompasses the contact surface 27 that includes the coded information. The adhesive layer 24 can include glue. Any number of well known, water-based adhesives can be employed and fall within the scope of the present invention. The glue can be applied to the structural layer 18 using any number of coating or laminating techniques, such as a spraying process. Once assembled, the laminate structure 22 can be manipulated, e.g., by any stamping process, to achieve a desired configuration.

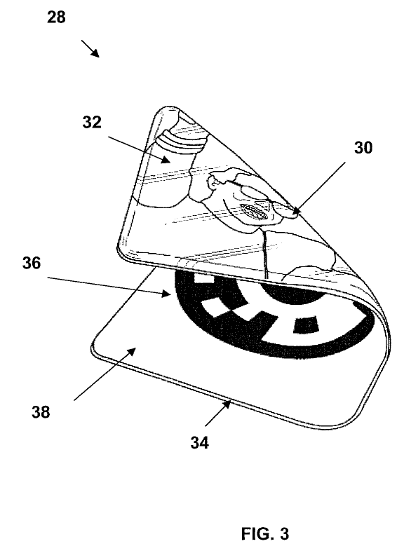

FIG. 3 is a schematic diagram illustrating the flexibility of the inventive laminate structure 28. The laminate structure 28 needs to be sufficiently flexible so as to allow for continuous re-attachments to several portable electronic devices. The removal from a portable electronic device requires peeling the laminate structure 28 from the surface of a portable electronic device, which requires bending the laminate structure 28. This requires the laminate structure to have a fair amount of flexibility as well as maintaining its flexibility during several re-attachments. Moreover, the peeling and bending of the laminate structure 28 should not damage the image 32 displayed on the ornamental layer 30 as well damage or smear the substrate 34, the coded information 3, and the adhesive layer 38. The adhesive layer 38 comprises materials that will not leave a residue once removal occurs on a surface. The laminate structure 28 is constructed in such a way to allow for sufficient flexibility and durability across multiple re-attachments.

Although the present invention has been shown and described with respect to several preferred embodiments thereof, various changes, omissions and additions to the form and detail thereof, may be made therein, without departing from the spirit and scope of the invention.

What is claimed is:

1. A laminated structure comprising:
an ornamental layer providing structural support and decorative graphics;
a substrate positioned below said ornamental layer, said substrate includes a contact surface on which coded information is printed, said coded information includes information associated with a uniform remote location (URL) used in downloading selective content information to a portable electronic device; and
an adhesive layer being positioned and totally encompassing said contact surface and said coded information, said adhesive layer being constructed and arranged to adhere to the surface of a portable electronic device.

2. The laminated structure of claim 1, wherein said adhesive layer comprises an adhesive used to adhere the laminate structure to the surface of said portable electronic device without leaving no residue once the laminate structure is removed.

3. The laminated structure of claim 1 further comprising a structural layer being disposed between the ornamental layer and the substrate, and is adapted to provide structural stability to the laminate structure.

4. The laminated structure of claim 1, wherein said code information comprises 2-D coded symbols or graphical sequences.

5. The laminated structure of claim 1, wherein said portable electronic device provides a selective software code that identifies said bar-coded information and access said URL.

6. The laminated structure of claim 5, wherein said portable electronic device comprises a camera to take a picture of said coded information for identification by said selective software code.

7. The laminated structure of claim 5, wherein said selective content information is downloaded with the aid of said selective software code.

8. The laminated structure of claim 1, wherein said portable electronic device has web accessibility.

9. A method of forming a laminated structure comprising:
forming an ornamental layer providing structural support and decorative graphics; and
positioning a substrate below said ornamental layer, said substrate includes a contact surface on which coded information is printed, said coded information includes information associated with a uniform remote location (URL) used in downloading selective content information to a portable electronic device; and
forming an adhesive layer being positioned and totally encompassing said contact surface and said coded information, said adhesive layer being constructed and arranged to adhere to the surface of said portable electronic device.

10. The method of claim 1, wherein said adhesive layer comprises an adhesive used to adhere the laminate structure to the surface of said portable electronic device without leaving no residue once the laminate structure is removed.

11. The method of claim 9 further comprising a forming structural layer being disposed between the ornamental layer and the substrate, and is adapted to provide structural stability to the laminate structure.

12. The method of claim 9, wherein said code information comprises 2-D coded symbols or graphical sequences.

13. The method of claim 9, wherein said portable electronic device provides a selective software code that identifies said bar-coded information and access said URL.

14. The method of claim 13, wherein said portable electronic device comprises a camera to take a picture of said coded information for identification by said selective software code.

15. The method of claim 13, wherein said selective content information is downloaded with the aid of said selective software code.

16. The method of claim 9, wherein said portable electronic device has web accessibility.
